(19) United States
(12) Patent Application Publication
(10) Pub. No.: US 2026/0276550 A1
(43) Pub. Date: Sep. 17, 2026

(54) HIGHLY SENSITIVE SURFACE ENHANCED RAMAN SCATTERING (SERS) SENSOR USING METAL ORGANIC FRAMEWORK (MOF) SUBSTRATE AND FIBER OPTICAL CHANNELS AND METHODS OF MANUFACTURING AND USING THE SAME

(71) Applicant: HOA THI LAI, Ho Chi Minh City (VN)

(72) Inventors: NHU HOA THI TRAN, Ho Chi Minh City (VN); NGOC TRAN LA NGUYEN, Ho Chi Minh City (VN); THANG BACH PHAN, Ho Chi Minh City (VN)

(73) Assignee: CENTER FOR INNOVATIVE MATERIALS AND ARCHITECTURES, VIETNAM NATIONAL UNIVERSITY HOCHIMINH CITY, Ho Chi Minh City (VN)

(21) Appl. No.: 19/079,496

(22) Filed: Mar. 14, 2025

(51) Int. Cl. G01N 21/65; B01J 20/22

(52) U.S. Cl. CPC G01N 21/658; B01J 20/226; G01N 2201/06113

(57) ABSTRACT

A surface enhanced Raman spectroscopy sensor (SERS sensor) and a method for detecting foreign substances are disclosed. The SERS sensor includes a laser source, an input fiber optic cable, a microfluidic chip coupled to the input fiber optic cable, and a computer electrically coupled to an output fiber optic cable. The microfluidic chip includes an inlet channel, a Si/OH/Au-ZIF8 platform, and an outlet channel. Coupled to the inlet channel is a micro-pump device operable to pump a sample liquid from the inlet channel to the outlet channel via the Si/OH/Au-ZIF8 platform. Coupled to the outlet channel is the output fiber optic cable.

Please replace the originally filed Specification on Mar. 14, 2025 by the following substitution specification under 37 C.F.R. § 1.121 (b) (3) (ii) and in compliance with C.F.R. § 1.125 (b) and (c).

### FIELD OF THE INVENTION

The present invention relates generally to nanotechnology for sensing. More specifically, the present invention relates to surface enhanced Raman spectroscopy (SERS) sensors.

### BACKGROUND ART

With the advance of nanotechnology, sensors that are based on nanomaterials such as Materials of Lavoisier Institute (MIL-101), metal organic framework (MOF), isoreticular metal organic framework (IRMOF) are designed to detect minuscule traces of toxic materials such as malachite green (MG in short for N-methylated diaminotriphenylmethane dye), auramine, rhodamine B, and other unknown materials. At the same time, surface-enhanced Raman spectroscopy (SERS) is an emerging technology that combines Raman spectroscopy and nanotechnology to detect and accurately characterize molecular structure.

In Raman spectroscopy, when light shines on a sample, part of the light directly penetrates the sample with an unchanged direction and unchanged energy. Part of the light is scattered in all directions. The scattered light with changing direction and constant energy is called Rayleigh scattering. The scattered light with changing direction that is accompanied by an increase or decrease in energy is called Raman scattering. The decrease in energy of the scattered light includes Stokes lines. The increase in energy is called anti-Stokes lines. The difference between the frequency of the Stokes and anti-Stokes and the frequency of the excited light source is called the Raman shift. The change of vibrational energy level of different molecules leads to the change of Raman shift, thus identifying different molecules. Therefore, Raman scattering can be used to study the vibrational energy level of the target molecule in the detected sample because different molecules of different substances have different vibrational energy levels due to their unique chemical bonds and groups. For this reason, the Raman spectroscopy is used to analyze the structural composition characteristics of molecules, which is also known as the molecular fingerprint spectrum. However, for the detection of low concentration substances, the Raman spectroscopy is not effective because the scattered signals are weak. Actually, both input and output signals are easily affected by optical system parameters. In addition, the presence of fluorescence scattering can affect the signal of the sample. Therefore, the Raman spectrum is mostly used to detect solid samples or aqueous solution of high concentration, but is not suitable for minuscule trace component analysis.

An improvement to the Raman spectroscopy discussed above is a surface-enhanced Raman scattering (SERS). SERS is a more sensitive technology that amplifies Raman intensity by plasmon effects. The enhancement of Raman spectral intensity mainly comes from the electromagnetic interaction between light and metal. The interaction greatly enhances the surrounding electromagnetic field through plasmon resonance excitation or hotspot. The Raman signal is amplified through the combination of the specific scattering of the target molecule and the excitation of local surface plasmons of the surface material. In other words, the plasmon effects combine the phenomena of light-molecular interactions (vibrational spectroscopy) and light-metal interactions (local surface plasmon resonance). According to a recent report, the enhancement factor of the metal surface can be up to 10⁶-10⁸. Research has also found that the largest enhancement occurs on rough surfaces at the nanoscale for which enhancement factor can be as high as 10¹⁰-10¹¹. It has been found that the higher the surface roughness of nanoparticles, the better the enhancement effect.

For the above reasons, Raman spectroscopy has been widely used in food safety detection, including microscopic Raman spectroscopy, Raman imaging, and SERS. SERS has been continuously improved, and it has been extensively applied as a powerful biochemical fingerprinting method. Based on the advantages of SERS, its application in food field is very extensive, including quantitative analysis, qualitative analysis, and structural analysis. Some examples of SERS analyses include: (1) basic ingredient detection; (2) toxic and harmful substances detection including food additives, pesticide residues, heavy metals, microbial toxins, and food-borne pathogens; and (3) Microbial detection and identification.

However, SERS sensors retain many problems such as stability, component variety, and sensitivity. The prior-art SERS sensors incur stability problem because their light sources are easily disturbed, leading to unstable measurements. In addition, the prior-art SERS can only detect a specific substance, e.g., dopamine. Various target molecules cannot be detected. This limits the usability of the prior-art SERS sensors. Furthermore, even with the type of substance they were designed to detect, the prior-art SERS sensors cannot detect traces that have low concentration. In order to obtain the Raman spectra for different target molecules, many attempts have been explored.

In 2015, Yi He and his colleagues synthesized silver nanoparticles in situ on the surface of the metal-organic framework material MIL-101 (Fe) for a sensor to detect dopamine. [Yi He et al., Facile in Situ Synthesis of Silver Nanoparticles on the Surface of Metal-Organic Framework for Ultrasensitive Surface-Enhanced Raman Scattering Detection of Dopamine, Analytical Chemistry, 2015, 87, 12177-12182]. Taking advantage of the resonance effect of silver nanoparticles, the electromagnetic enhancement enhances the Raman signal of the target molecule. In addition, MIL-101 (Fe) material has a large surface area that can adsorb molecules inside the porous structure. The material was formed by using tannic acid on the surface of MIL-101 (Fe) to immobilize silver nanoparticles. However, this synthesis process is complex, difficult to control, and the sensor's detection performance is not high.

In 2019, O. Guselnikowa and colleagues synthesized a metal-organic framework material (MOF-5) on top of a gold metal layer. [O. Guselnikowa et al., Metal-organic framework (MOF-5) coated SERS active gold gratings: A platform for the selective detection of organic contaminants in screening, Analytica Chimica Acta, 1068 (2019), 70-79]. This combination of materials is capable of detecting organic pollutants in soil through the surface-enhanced Raman scattering (SERS) technique. In addition, MOF-5 material increases surface uniformity and protects the underlying gold layer. However, this material does not achieve a high Raman enhancement coefficient.

In 2021, N.T.T. Phuong and colleagues have announced that silver nanomaterials in cubic shape have the ability to detect the toxin rhodamine B in food. [N.T.T. Phuong et al., Rapid and sensitive detection of Rhodamine B in food using the plasmonic silver nanocube-based sensor as SERS active substrate, Spectrochimica Acta PartA: Molecular and Biomolecular Spectroscopy 263 (2021) 1 20179]. This nano silver material has signal stability and durability over long storage periods. However, this material has a low detection limit for rhodamine B molecules.

Therefore, what is needed is a nanomaterial that can improve the sensitivity of surface enhanced Raman spectroscopy (SERS).

What is needed is a nanomaterial that can provide durability and stability of the SERS sensors and detectors.

What is needed is a SERS sensor/detector that does not use toxic materials as substrate.

What is needed is a SERS sensor or detector that has short reaction time and can be produced in industrial scale.

What is needed is a method of making a SERS sensor/detector that is simple and low-cost.

The method and the nanomaterial of the present invention meet the above needs and solve the above-described problems.

### SUMMARY OF THE INVENTION

Accordingly, an object of the present invention is to provide a method and surface enhanced Raman spectroscopy (SERS) sensor that to improves conversion sensitivity, stability, and usability.

Another object of the present invention is to provide a hybrid nanomaterials such as Si/OH/Au-ZIF 8 platform that enables SERS sensors to be used with fiber optics cables.

Another object of the present invention is to provide a surface enhanced Raman spectroscopy sensor (SERS sensor) and a method for sensing foreign substances using the SERS sensor are disclosed. The SERS sensor includes: a laser source, an input fiber optic cable, a microfluidic chip coupled to the input fiber optic cable. The microfluidic chip includes an inlet channel, a Si/OH/Au-ZIF 8 platform, and an inlet channel. Coupled to the inlet channel is a micro-pump device operable to pump a sample liquid from the inlet channel to the outlet channel via the Si/OH/Au-ZIF8 platform, an output fiber optic cable coupled to the outlet channel, and a computer electrically coupled to the output fiber optic cable.

Another object of the present invention is to provide a method for detecting foreign traces in a test liquid using an ultra-sensitive SERS sensor is disclosed which includes: flowing the test liquid through an inlet channel, a Si/OH/Au-ZIF 8 platform, and an outlet channel of a microfluidic chip of the SERS sensor; turning on a He/Ne laser source of the SERS sensor; receiving scattering frequencies from the test liquid through said Si/OH/Au-ZIF8 platform using a photodetector of the SERS sensor; and measuring intensities of the Raman scattering frequencies using a computer of the SERS sensor.

Another object of the present invention is to provide a method of fabricating an ultra-sensitive surface enhanced Raman spectroscopy (SERS) sensor is disclosed which comprises: connecting a laser source to an input fiber optics cable; connecting a microfluidic chip to the input fiber optic cable, the microfluidic chip further comprising an inlet channel, a Si/OH/Au-ZIF8 platform, and an inlet channel; connecting a micro-pump device to the inlet channel; connecting an output fiber optic cable couple to the outlet channel; and connecting a computer to the output fiber optic cable using a photodetector.

These and other advantages of the present invention will no doubt become obvious to those of ordinary skill in the art after having read the following detailed description of the preferred embodiments, which are illustrated in the various drawing and figures.

### BRIEF DESCRIPTION OF THE DRAWINGS

The accompanying drawings, which are incorporated in and form a part of this specification, illustrate embodiments of the invention and, together with the description, explain the principles of the invention.

FIG. 1 is a flowchart of a method for manufacturing an Si/OH/Au-ZIF8 platform enhanced Raman spectroscopy substrate in accordance with an exemplary embodiment of the present invention;

FIG. 2 is a flowchart of a method for fabricating a SERS sensor using an Si/OH/Au-ZIF8 platform coupled to fiber optic channels in accordance with an exemplary embodiment of the present invention;

FIG. 3 presents a perspective diagram that illustrates the manufacturing process of the Si/OH/Au-ZIF8 platform enhanced Raman spectroscopy substrate in accordance with an exemplary aspect of the present invention;

FIG. 4 presents a perspective diagram of the SERS sensor using an Si/OH/Au-ZIF 8 platform coupled to fiber optic channels in accordance with an exemplary embodiment of the present invention;

FIG. 5A represents Raman signals of nitrofurantoin (NFT) molecule at different concentration;

FIG. 5B represents a best fit curve between a detected concentration level and SERS intensity

FIG. 5C represents bar chart of varying Raman intensities of NFT on AuZIF 8 substrate;

FIG. 5D represents the Raman spectral at 10⁻⁴ M concentration of NFT collected from 16 random positions on SERS sensor.

FIG. 6A is a graph representing the function of transmission intensity versus time;

FIG. 6B is a graph representing the function between transmission intensity versus the concentration of NFT mixture;

FIG. 6C are graphs of the reactions based on local surface plasmon resonance (LSPR) according to concentration of sulfadiazine (SDZ) and 4-ntrianiline (4-NA).

FIG. 6D shows the transmitted power of the sensor with injected analyte concentrations of 4-nitroaniline (4-NA).

The above figures are for the purposes of illustration only. A person of ordinary skill in the art will readily recognize from the following discussion that alternative embodiments of the structures and methods illustrated herein may be employed without departing from the principles of the technology described herein.

### DETAILED DESCRIPTION OF THE INVENTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth to provide a thorough understanding of the present invention. However, it will be obvious to one of ordinary skill in the art that the present invention may be practiced without these specific details. In other instances, well-known methods, procedures, components, and circuits have not been described in detail so as not to unnecessarily obscure aspects of the present invention.

Within the scope of the present description, the reference to “an embodiment” or “the embodiment” or “some embodiments” means that a particular feature, structure, or element described with reference to an embodiment is comprised in at least one embodiment of the described object. The sentences “in an embodiment,” “in the embodiment,” or “in some embodiments” in the description do not, therefore, necessarily refer to the same embodiment or embodiments. The features, structures, or elements can be furthermore combined in any adequate way in one or more embodiments.

The present invention provides a method for fabricating a Si/OH/Au-ZIF8 platform capable of coupling to fiber optic channels; the platform improves the sensitivity, stability, and usability of SERS sensors. The method includes the steps of preparing a silica (SiO₂) substrate, carrying out a plasma oxidation process to form-OH bonds on the surface of the silica membrane, preparing AuZIF 8 hexagons with the size of the gold (Au) nano particles between 15 nm-20 nm, and coating the silica substrate with the AuZIF 8 by the hydroxyl (—OH) moiety.

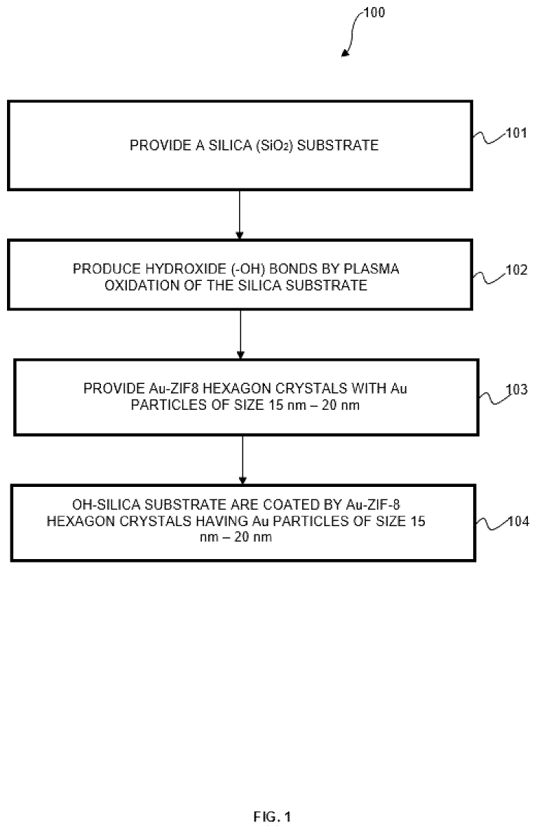

Now referring to FIG. 1, a flowchart of a process 100 for manufacturing a Si/OH/Au-ZIF 8 platform enhanced Raman spectroscopy substrate in accordance with an exemplary embodiment of the present invention is illustrated. Process 100 is a simple process that provide a Si/OH/Au-ZIF 8 platform for the highly sensitive SERS detector capable of incorporating fiber optic cables at the input and output terminals. In addition, process 100 does not use rare and expensive chemical elements.

At step 101, a silica (SiO₂) substrate is provided. Silica is also known as silicon dioxide (SiO₂). It is commonly used as a substrate material coatings due to its high chemical and thermal stability. It is also a good electrical insulator. Normally, SiO₂ is formed by chemical vapor deposit (CVD) of SiO₂ on a substrate. Alternatively, a thermal oxidation is performed on a silicon (Si) film to form the silica substrate.

Next at step 102, hydroxyl functional group (—OH) is grown on the silica substrate by a plasma oxidation process. In various aspects of the present invention, step 102 is realized by the plasma oxidation process. Hydrophilic hydroxyl (—OH) groups are grown on the surface of silica substrate via oxidation using the plasma treatment system. This process promotes covalent bonding and results in a well-integrated AuZIF 8 film layer. In the plasma oxidation process, the surfaces of the silica substrate are oxidized in an oxygen gas discharge via active neutral and charged oxygen species for approximately 2 minutes. As a result of step 102, hydroxyl functional group is grown on the surface of the silica substrate.

Next, at step 103, AuZIF8 hexagon crystals with Au particles of size 15 nm-20 nm are prepared. Step 103 is implemented by various methods. In one exemplary aspect of the present invention, metal-organic framework materials (ZIF 8) and gold metal nanomaterials with a volume ratio of 1:2 with high density are used. In another exemplary aspect of the present invention, hybrid metal nanomaterials with organometallic frameworks (AuZIF8) is synthesized using metal-organic framework materials (IMROF-3) and gold metal nanomaterials with a volume ratio of 1:2. In another aspect of the present invention, hybrid metal nanomaterials with an organometallic framework (AuZIF 8) is synthesized using the metal-organic framework material MIL-100 (Fe) and nanometal gold with a volume ratio of 1:2. In one exemplary aspect of the present invention, hybrid metal nanomaterials with organometallic frameworks (AuZIF8) is synthesized using metal-organic framework materials MIL-100 (Fe) and gold nanomaterials with a volume ratio of 1:2. In another exemplary aspect of the present invention, hybrid metal nanomaterials with organometallic frameworks (AuZIF8) is synthesized using the metal-organic framework material MIL-100 (Fe) and nanometal iron oxide with a volume ratio of 1:2. In yet other exemplary aspect of the present invention, hybrid metal nanomaterials with organometallic frameworks (AuZIF8) is synthesized using the metal-organic framework material MIL-100 (Fe) and nanometal iron oxide with a volume ratio of 1:2. In one exemplary aspect of the present invention, hybrid metal nanomaterials with organometallic frameworks (AuZIF 8) is synthesized using metal-organic framework materials (ZIF 8) and iron oxide nanometals with a volume ratio of 1:2.

At step 104, the AuZIF 8 hexagon crystals are coated on the surface of the silica substrate. Step 104 is realized by dipping the silica substrate modified by the hydroxyl (—OH) moiety in a solution of AuZIF8 for 24 hours. Prior to functionalization, the optical fiber is sequentially cleaned with acetone and ethanol solutions, followed by rinsing with distilled water. After surface hydroxylation using plasma oxidation for approximately 2 minutes, the optical fiber was immersed in an AuZIF 8 precursor solution for 120 minutes at room temperature. Finally, the modified fiber is s retrieved and rinsed with anhydrous ethanol. These steps constitute a complete ZIF 8 self-assembly cycle. The AuZIF 8 platform is fabricated through a rapid and straightforward process with minimal intermediate steps, thereby reducing potential risks, enhancing film stability, and allowing precise control over reaction parameters and conditions. These advantages make this method superior to conventional fabrication techniques.

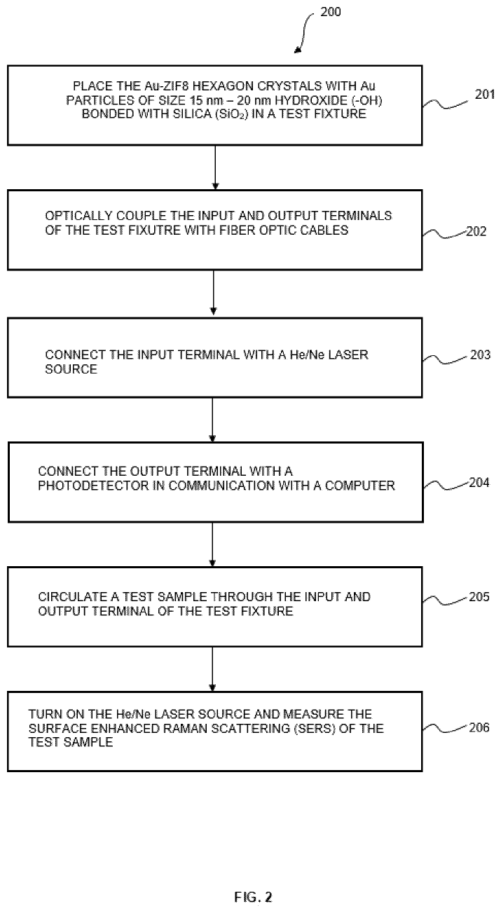

Next, referring to FIG. 2, a flow chart of a process 200 for making a highly sensitive SERS sensors in accordance with an exemplary aspect of the present invention is illustrated.

At step 201, a SERS platform including AuZIF 8 hexagons with Au nano particles having a size of 15 nm-20 nm bonded with a hydroxide silica substrate is formed. Step 201 is realized by method 100 above.

At step 202, optical fiber channels are coupled to the input and output terminals of the SERS substrate. Prior to functionalization, the optical fiber should be sequentially cleaned with acetone and ethanol solutions, followed by rinsing with distilled water. After surface hydroxylation using plasma oxidation for approximately 2 minutes, the optical fiber was immersed in an AuZIF 8 precursor solution for 120 minutes at room temperature.

At step 203, a He/Ne laser source is coupled to the input terminal. Step 203 is realized by an optical coupler at the input terminal and a photodetector at the output terminal. A 5 mW He/Ne laser source (LASOS LGK 7628) with an absorption wavelength of 632.8 nm is used to realize step 203.

At step 204, a computer is coupled to the output terminal. Step 204 is realized by connecting a computer to the photodetector. The photodetector used in step 204 is digital handheld optical source (PM 100D, Thor Labs, Newton, NJ, USA).

At step 205, a micro pump is connected to the SERS substrate. Step 205 is realized by a peristaltic pump (Eleya, SMP-21, Japan) that is connected through a plastic tube (Inner diameter: Outer diameter=1.15:3.2 mm) controlled to have a flow rate of 1 minute.

Finally, at step 206, the SERS of the test sample is measured. Step 206 is realized by first turning on the He/Ne laser source and pumping the test sample through the SERS platform using the micro pump.

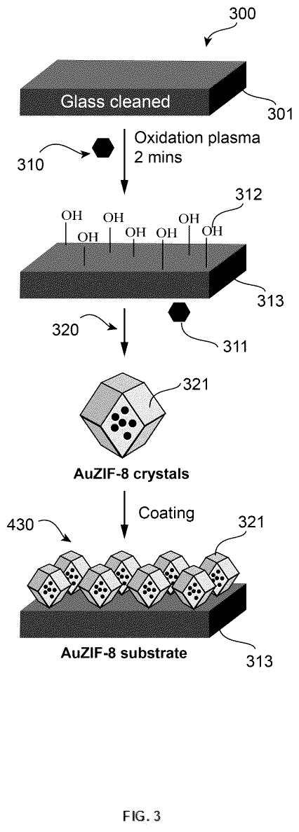

Referring to FIG. 3, a perspective diagram 300 illustrating the manufacturing process 100 in accordance with an exemplary aspect of the present invention is shown. First, a silica substrate 301 is cleaned. Next, at a step 310, glass foundation 301 is undergone an oxidative plasma process 310. A plasma oxidation 310 is a process whereby surfaces of the silica substrate 301 are oxidized in an oxygen gas discharge via active neutral and charged oxygen species 311. As a result, a hydroxyl functional group 312 is grown on the surface of the silica substrate 313 which is silica substrate 301 modified by the —OH moiety. Oxidative plasma process 310 is described briefly in step 102 above.

Continuing with FIG. 3, in a process 320, AuZIF 8 hexagon crystals with Au particles of size 15 nm-20 nm are prepared. Process 320 is the same as step 103 described above and in Examples 1-7. The oxidized silica substrate is coated with AuZIF8 hexagon crystals 321 by submerging the solution of AuZIF 8 for 24 hours. Finally, a Si/OH/Au-ZIF 8 platform 430 capable of coupling with fiber optical cables in SERS sensors of the present invention is obtained.

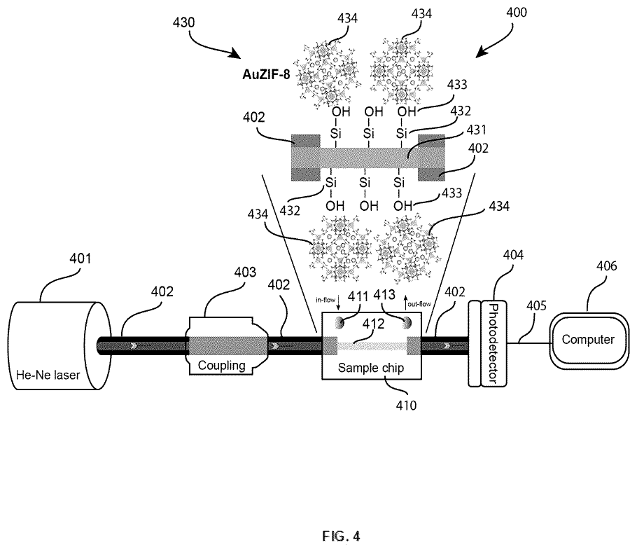

Referring now to FIG. 4, a perspective diagram of a highly sensitive SERS sensor 400 implemented with Si/OH/Au-ZIF8 platform 430 in accordance with an exemplary embodiment of the present invention is illustrated. SERS sensor 400 is highly sensitive and stable in detecting of molecular traces of contaminants. This is because hybrid Si/OH/Au-ZIF8 platform fabricated by method 100 can operate with fiber optic cables at the input and output terminals.

A He/Ne laser source 401 is connected to fiber optical cable 402 at the input terminal. In practice, 5 mW He/Ne laser (LASOS LGK 7628) with an absorption wavelength of 632.8 nm is used for He/Ne laser source 401. An optical coupler 403 couples fiber optical fiber cable 402 to a sample chip 410. Sample chip 410 includes Si/OHAu-ZIF8 platform 430 described above in FIG. 3. Sample chip 410 also includes an input fluidic terminal 411 and output fluidic terminal 413, which couple to Si/OH/Au-ZIF 8 platform 430. A micro-pump 415 couples to input fluidic terminal 411 to pump a test sample through sample chip 410. A photodetector 404 is coupled to output terminal via optical fiber cable 402. Photodetector 404 is electrically connected to a computer 406. Photodetector 404 is the digital handheld optical source (PM 100D, Thor Labs, Newton, NJ, USA) connected to computer 406 to measure the fiber output signal and record laser intensity records through the power of light transmitted through fiber optics 402. Sample chip 410 is a microfluidic chip. Micro-pump 415 is a peristaltic pump (Eleya, SMP-21, Japan) is connected through a plastic tube (Inner diameter: Outer diameter=1.15:3.2 mm) controlled to have a flow rate of 1 minute.

In operation, SERS sensor 400 is a hybrid-plasmonic metal-organic framework (MOF), especially ZIF8. SERS sensor 400 is functionalized on an optical sensor comprised of fiber optical cable 402, optical coupler 403, and photodetector 404, which utilizes a mismatch mechanism of waveguide mode. SERS sensor 400 is able to detect target analytes in aqueous environment. Au nanoparticles (AuNP s) in coordinated ZIF 8 structures in Si/OH/Au-ZIF 8 platform 430 are immobilized onto the surface of a fabricated multimode optical fiber cable 402 via a self-growth technique. This yields an extensive surface are for enhanced sensing performance. Within the evanescent wave fields surrounding the excitation region of SERS sensor 400, the AuZIF 8 nanostructures functionalize the SMF surface through strong electrostatic adsorption and Tt-TT stacking interactions. Most ZIF 8 materials of Si/OH/Au-ZIF8 platform 430 now exist as composite nanocrystals. As such, the present invention integrate the ZIF 8 with plasmonic nanoparticles AuNPs to form a hybrid-plasmonic porous structure. The bonding angle of approximately 145° of Si—O—Si in optical fiber cables 402 facilitates structure compatibility. The hydrophilic-OH groups further act to ensure the stable formation of AuZIF 8 thin film on the fiber surface of optical fiber cables 402. Especially, the introduction of hydrophilic hydroxyl groups via oxidation using the plasma treating process promotes covalent bonding that results in well-integrated between AuZIF 8 and optical fiber cables 402.

Continuing with FIG. 4, Si and a-Si surfaces 433 mainly consist of hydride (Si-Hx) terminations with a low density of hydroxyl groups (Si—OH silanols) 433 due to oxidation phenomena. This represents the most reactive substrates because isolated silanols are free to react and promote proton exchange. The reactivity of hydroxyl groups 433 decreases as their density increases, likely due to the cross-linking of hydrogen bonds and the overall rise in oxygen content, thus making quartz a less reactive surface compared to Si. Native SiO₂ 431 is the least reactive surface due to the high density of silanols, which form rigid siloxane bridges that prevent direct functionalization. Therefore, SiO₂ surfaces 431 require an oxidation process to activate free radicals, enabling interaction and the formation of a functionalized layer. For AuZIF 8 materials 434, AuNP s are loaded onto the porous ZIF 8 structure. Meanwhile, the deprotonation of imidazole either from isolated imidazole molecules is the key step in crystal growth, leading to the homogeneous formation of AuZIF 8 on silica substrates 431.

In summary, SERS sensors 400 is fabricated by methods 100 and 200 above to obtain extensive surface area for enhanced sensing performance. SERS sensors 400 is ultra-sensitive and stable to the point that it is capable of detecting for target analytes in aqueous environment. This is because Au nanoparticles (AuNP s)-coordinated ZIF 8 structures are immobilized onto the surface of the fabricated multimode optical fiber 402 via a self-growth technique, yielding an extensive surface area for enhanced sensing performance.

### Experiments and Results

The rectilinear flow cell structure molded with polydimethylsiloxane (PDMS) and clean glass has two ports for the inlet and outlet of the microfluidic flow solution channel. To make PDMS network samples, Sylgard 184 silicone elastomer with standard 10:1 (v/V) cross-linked silicone base and curing agent was used. It is important to maintain the mixture under a desiccator vacuum before the curing process to remove air bubbles from the mixture in subsequent phases. Then put into the mold and dry in the oven for 30 minutes at 70° C. for the curing stage. Allowing the fluid to enter the microfluidic, the inlet and outlet streams are punctured using a 1 mm circular metal punch. The beam light emitted from a 5 mW He/Ne laser (LASOS LGK 7628) with an absorption wavelength of 632.8 nm was used.

Other light in the cladding fiber is eliminated with an aperture collimator holder to integrate the fiber components into the optical setup in front of the power sensor head. Digital handheld optical source (PM 100D, Thor Labs, Newton, NJ, USA) connects to a computer to measure the fiber output signal and record laser intensity records through the power of light transmitted through fiber optics. To inject liquid into the channel containing the sensor tip, a microfluidic chip connected to a peristaltic pump (Eleya, SMP-21, Japan) is used through a plastic tube (Inner diameter: Outer diameter=1.15:3.2 mm) controlled to have a flow rate of 1 minute.

### Surface-Enhanced Raman Spectroscopy (SERS) Measurements

Nitrofurantoin (NFT), sulfadiazine (SDZ), and 4-nitroaniline (4-NA) solutions were used to study the Raman signal capability of the Si/OH/AuZIF8 mixture. First, 10 mL of each analyte in varying concentrations (from 10⁻⁴ to 4 UM of NFT, from 10⁻⁴ to 100 nM of SDZ, and from 10⁻⁷ to 0.1 nM of 4-NA) were produced, then approximately 20 ml of analyte solutions at various concentrations was dropped onto the glass substrate and immediately record Raman measurements when the sample dries. The SERS spectra were collected from randomly selected points on the SERS substrate for each sample, then they were averaged to reduce randomization error.

Surface properties of the AuZIF 8 substrate were evaluated using a 5 KV field emission scanning electron microscope (Hitachi S-4800, Japan). Images were taken at various sizes and in various positions of the sample. When used in conjunction with EDX, it is possible to determine the elemental structure of any item in the area under investigation. To establish the maximum absorption wavelength, the UV-vis spectrum of the AuZIF 8 was collected in a V-730 visible/NIR (wavelength range 200e1100 nm) spectrometer (JASCO, Tokyo, Japan).

The crystallinity of the material was measured with a Bruker D8 Advance diffractometer using Ni-filtered Cu K ( )=1.54178 Å) radiation at 40 kV, 40 mA (1,600 W) in the 5 e80 range. Raman spectra were recorded using a HORIBA XploRA One (HORIBA Scientific, HORIBA Ltd., HORIBA Europe GmbH) confocal microprobe Raman system with holographic filter and liquid nitrogen-cooled CCD detector.

### Preparation and Characterization of Si/OH/AuZIF8 Substrate

The synthesized Au nano particles (Au NPs) showed characteristic excitation and absorption peaks at 519 nm, corresponding to previous papers. The successful attachment of Au NPs on the AuZIF 8 surface is highlighted in UV-Vis experiments by distinct metal and organic peaks at 524 nm.

Attachment of Au NPs can also affect the optical performance properties of the pendant organic ligands, leading to visible production of the desired AuZIF8 composites. Furthermore, when the frequency of the electromagnetic field becomes resonant with the coupled motion of the electron, significant absorption occurs, which is the source of the color of AuZIF 8 produced as a golden brown.

The X-ray diffraction (XRD) patterns of the produced ZIF 8 and AuZIF 8 films are compatible with the simulation patterns. Test results show that the monolayer film is effectively constructed. In addition, the intensity of the Au peaks is larger than that of other peaks, indicating that the Ag NPs grow mainly in the crystallographic (111) direction and have a face-centered cubic (FCC) structure. The diffraction peak intensity demonstrates that the AuZIF 8 composites are well crystallized, have high stability, and a uniform composite layer.

The FESEM investigation indicated that the Au NPs were spherical in shape with an average size of 15 nm and uniformly monodispersed on the glass surface, while ZIF8 was about 600 nm in diameter with a regular hexagonal structure. However, (transmission magnetic) TEM images of the AuZIF8 composites clearly show that the Au NPs have a sphere-like structure with an average diameter of about 19 nm, which is consistent with the size distribution of the as-modified Au NPs. prepared from a single process. Uniform density of Au NPs inside AuZIF8, results in dispersed and intermediate gaps between nanoparticles for suitable substrates. This is important because it creates a large number of “hot spots” that create a strong electromagnetic field, leading to the formation of a SERS active region on the sensor surface.

### Effective SERS of AuZIF8 Panels

The SERS performance of Si/OH/Au-ZIF8 platform 430 by Raman spectra of NFTs (10⁻⁷ M and 10⁻³ M) was detected, showing a stronger SERS signal with a detection limit of 81.3 nM. The density distribution of the component elements of the AuZIF 8 matrix was determined by energy dispersing X-ray (EDX) and EDX mapping techniques, clear signals for the elements Zn, Au, O and N are chemical elements present in the structure Si/OH/Au-ZIF 8 platform and without any other impurities, which confirms the successful synthesis of Si/OH/Au-ZIF8.

### Selectivity, Uniformity and Stability of the AuZIF8 Substrate

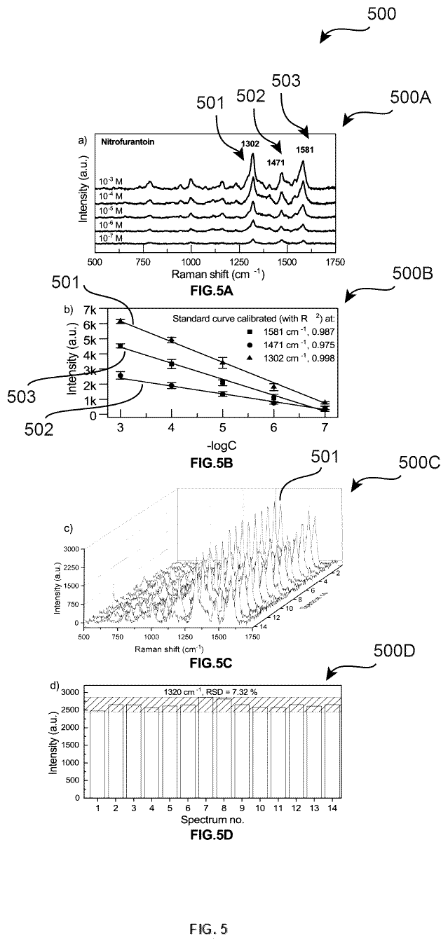

Now referring to FIG. 5A, a graph 500A of intensity versus Raman shift of Nitrofurantoin (NFT) at different concentration levels using Si/OH/Au-ZIF 8 platform 430 is illustrated. To test the sensitivity of Si/OH/Au-ZIF 8 platform 430, the Raman signal of the mixed solution containing the same concentration of NFTs was collected on Si/OH/Au-ZIF8 platform 430. On graph 500A, different concentration levels of NFT are clearly marked: 10⁻⁷ M, 10⁻⁶ M, 10⁻⁵ M, 10⁻⁴ M, and 10⁻³ M. Even at concentrations as low as 10⁻⁷ M, the main characteristic peaks 501 (1320 cm⁻¹), 502 (1471 cm⁻¹), 503 (1581 cm⁻¹) of different chemical components are consistent and always be distinguished. Therefore, Si/OH/Au-ZIF8 platform 430 in SERS sensor 400 shows potential applications in the rapid and convenient determination of toxic organic additives in any chemical.

Now referring to FIG. 5B, a graph 500B of intensity versus Raman shift of NFT at different concentration using Si/OH/Au-ZIF8 platform 430 is illustrated depicts the relationship of NFT concentration and corresponding Raman intensity with high confidence (>0.97) and a resonance enhancement factor reaching the highest of 1.42×10⁶ times estimated using an intensity at wavelength of 1320 cm⁻¹.

The SERS performance is attributed to the electromagnetic and chemical enhancement of NFTs and Si/OH/Au-ZIF8 platform 430. The enhancement may be due to hydrogen bonding or aromatic ring interactions involving TT-TT interactions (i.e., TT-TT stacking interactions) between Si/OH/Au-ZIF8 platform 430 and the NFT molecule. Furthermore, the pores of Si/OH/Au-ZIF 8 platform 430 play an important role in enhancing surface activity and promoting chemical enhancement, thus further improving SERS activity. In particular, the surface pores on Si/OH/Au-ZIF 8 platform 430 can provide more chemically active sites to adsorb NFT molecules, increasing the interaction affinity, thus enhancing the SERS signal through the transmission mechanism electric charge.

Continuing with graph 500B, a linear calibration plot 500B between SERS intensity and log of concentration (−Log (C)) for three selected peaks 501-503 of NFT using Si/OH/Au-ZIF 8 platform 430 in accordance with an exemplary aspect of the present invention is illustrated. Linear calibration plot 500B shows the responsiveness of Si/OH/Au-ZIF8 platform 430 in three different peaks 501-503 of the NFT. The hot spots of Au NPs play an important role in supporting electromagnetic enhancement leading to amplification of the Raman signal of the target analyte. This surface electromagnetic enhancement does only amplify the SERS signal but also increases the charge transfer rate between Au and ZIF8, even further increasing the SERS sensitivity. Therefore, the increases in the amount of Au nanoparticles lead to a significant increases in the electromagnetic fields near the interface of two neighboring Au nanoparticles causing plasmonic coupling of the Au nanoparticles.

Referring to FIG. 5C, a 3D spectral graph 500C of Raman spectra and relative standard deviation (RSD) values of three selected peaks (501-503) versus Raman shift and 14 different spectral locations of NFT using Si/OH/Au-ZIF8 platform 430 in accordance with an exemplary aspect of the present invention is illustrated. This demonstrates that the high SERS activity of Si/OH/Au-ZIF 8 platform 430 with high Au content is caused by increased interfacial hot spots and significant electric field enhancement caused by plasmon coupling. The good stability of the substrate was evaluated by recording SERS signals at 14 separate locations on Si/OH/Au-ZIF 8 platform 430 with a relative standard deviation (RSD) of 7.32% at Raman intensity of peak at 501 (1320 cm⁻¹).

Referring to FIG. 5D, a histogram 500D of the Raman intensity of peak 501 at 1320 cm⁻¹ and at 14 spots of the exposure time for each spot of NFT using Si/OH/Au-ZIF 8 platform 430 in accordance with an exemplary aspect of the present invention is illustrated. This demonstrates that the high SERS activity of the Si/OH/Au-ZIF 8 platform 430 with high Au content is caused by increased interfacial hot spots and significant electric field enhancement caused by plasmon coupling. The good stability of the substrate was evaluated by recording SERS signals at 14 separate locations on Si/OH/Au-ZIF8 platform 430 with a relative standard deviation (RSD) of 7.32% at 501 Raman intensity of peak at 1320 cm⁻¹.

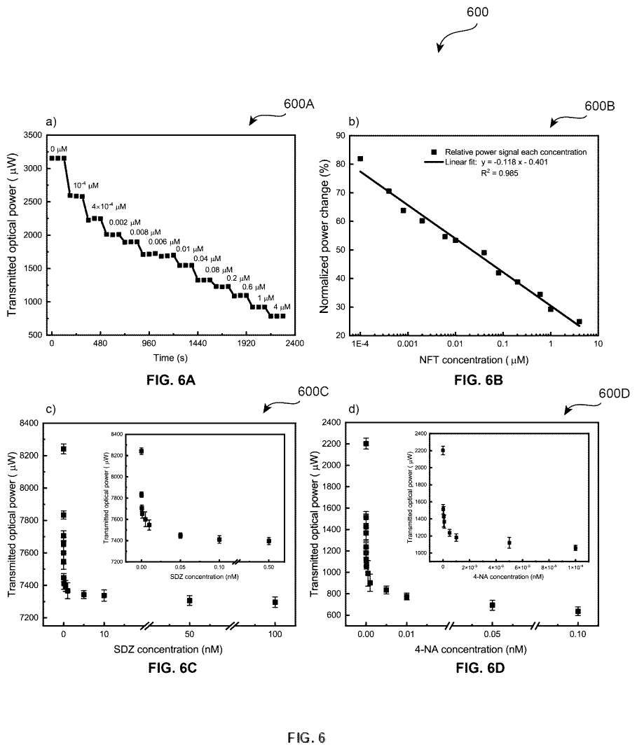

Now referring to FIG. 6A, a graph 600A shows the temporal variation of the output power as the NFT concentration increases sequentially in the range from 10⁻⁴ μM to 4 μM. The rapid decrease of the output power indicates the immobilization of NFT molecules into the pores of Si/OH/Au-ZIF 8 platform 430. A graph 600B in FIG. 6B shows a linear relationship between normalized output power (relative to input power) and the logarithm of nitrofurantoin (NFT) concentration with a confidence level higher than 0.985. The quantitative detection capacity for detecting NFTs in water reached a limit of 3.58×10⁻¹¹ M (35.8 PM).

Referring finally to FIG. 6C, a graph 600C shows the transmitted power of the sensor with injected analyte concentrations of sulfadiazine (SDZ @ 10-4 to 100 nM). The detection limit was calculated with SDZ as 2.23×10⁻¹⁴ M (22.3 fM). Such extremely high sensitivity for detecting all three antibiotics is largely due to the extremely large surface-to-volume ratio of the porous structure of the hybrid Si/OH/Au-ZIF 8 platform 430 and the inherent high sensitivity of the optical sensors to changes in spinal canal mismatch.

In FIG. 6D, a graph 600D shows the transmitted power of the sensor with injected analyte concentrations of of 4-nitroaniline (4-NA @ 10⁻⁷ to 0.1 nM). The detection limit was calculated with 4-NA as 2.21×10⁻⁷ M (22.1 aM). Such extremely high sensitivity for detecting all three antibiotics is largely due to the extremely large surface-to-volume ratio of the porous structure of the hybrid Si/OH/Au-ZIF 8 platform 430 and the inherent high sensitivity of the optical sensors to changes in spinal canal mismatch.

### Efficiency Achieved by the Invention

Si/OH/AuZIF8 composites of the present invention as SERS substrates and demonstrated that combining two enhancement mechanisms at the same time is a powerful strategy to improve SERS activity. Raman enhancement enables ultrasensitive detection of NFTs with a detection limit of 81.3 nM, respectively. The porous part of the Si/OH/Au-ZIF 8 platform allows large loading of Au NPs to create many “hot spots” to create strong electric field effects. Fiber optic sensors were also used, with detection limits of ultrasensitive molecules reaching 35.8 μM (NFT), 22.3 fM (SDZ), and 22.1 aM (4-NA).

The synthesis of the materials is quick and simple, given the lack of necessary equipment and their low cost. To improve the sensitivity of the sensor, in the future we will upgrade the SERS substrate based on ZIF8 and new metal materials such as controlling the shape and size of the matrix material or modifying the plate structural background. Si/OH/AuZIF8 composites are functional and extremely stable materials for SERS substrates and probe fiber sensors. Our research will provide many opportunities for immunoassays and clinical disease diagnosis in the medical and biological fields.

The highlight of the sensor substrate manufacturing method is to create a film of hybrid metal nanomaterials with an organometallic framework that is uniform and adheres well to the substrate surface thanks to the bonds formed between the substrate and the material, without any impurities, does not require high reaction temperature, does not require specialized equipment, compared to creating membranes by other chemical methods such as the sol-gel method, which requires separate equipment with many complex steps: impurities, the reaction temperature is very high, so it is only suitable for resistant substrates High temperature, time consuming, difficult to maintain membrane purity. Compared to creating films by physical methods such as physical vapor deposition method, which requires a vacuum generation equipment system (requiring high pressure) and a working chamber consisting of many complex steps, the substrate must be compatible. likes to limit the working surface and the process takes a long time to execute.

### IMPLEMENTATION EXAMPLES

### Example 1

Exemplary method for synthesizing hybrid metal nanomaterials with organometallic frameworks (SiO₂/OH/AuZIF8) using metal-organic framework materials (ZIF 8) and gold metal nanomaterials with a volume ratio of 1:2 with high density.

Step (a): creating a gold metal nano solution includes mixing gold (Au) nanoparticles with distilled water and diluting the gold metal nano solution from 5 times to 15 times. In this step, different gold nano solutions are diluted.

Step (b): create a ZIF 8 solution consisting of 103.25 mg of zinc nitrate hexahydrate salt, 83.53 mg of 2-methylimidazole, and 90.28 mg of polyvinylpyrrolidone (PVP) surfactant, and 50 ml of methanol solution stirred with a magnet for 1 hour at 950 rpm at 170° C. and washed twice with ethanol. Then add 4 ml of diluted silver nanometal solution dropwise into 2 ml of ZIF8 solution prepared in step a).

Step (c): keep the temperature stable at 25° C. and stir the mixture to perform the reaction for 8 hours;

Step (d) Collect the product by centrifugation for 20 minutes at 4000 rpm and wash three times with ethanol to remove surfactants;

Step v) then disperse the obtained product in 6 ml of dimethylformamide (DMF) solvent and collect the hybrid metal nanomaterial of the ultrasensitive organometallic frame with a ratio of 1:2 stored at room temperature. The product yield obtained is over 87%.

### Example 2

Another exemplary method for synthesizing hybrid metal nanomaterials with organometallic frameworks using metal-organic framework materials (IMROF-3) and gold metal nanomaterials with a volume ratio of 1:2

Step (a) create the reaction medium mixture by preparing the following precursor solutions:

Gold metal nano solution consisting of 100 ml of 1 mM gold (III) chloride trihydrate, 200 μl of 1 M sodium hydroxide (NaOH), 25 mg of sodium citrate tribasic dihydrate and 50 ml of distilled water stirred with a magnetic fish 15 minutes at 800 rpm at 100° C. and washed twice with distilled water.

Isoreticular metal organic framework-3 (IRMOF-3) solution includes 35.12 mg of zinc acetate salt, 10.86 mg of 2-aminoterephthalic acid, 10 mg of cetyl trimethyl ammonium bromide (CTAB) and 7.5 mg of polyvinylpyrrolidone (PVP) surfactant and 5 ml of N,N-solution dimethylformamide was stirred with a magnet for 30 minutes at a speed of 950 rpm at room temperature. 170° C. and washed twice with ethanol;

Step (b) dropwise add 4 ml of diluted gold nanometal solution to 2 ml of isoreticular metal organic framework-3 (IRMOF-3) solution prepared in step (a).

Step (c) keep the temperature stable at 25° C. and stir the mixture to perform the reaction for 8 hours;

Step (d) collect the product by centrifugation for 20 minutes at 4500 rpm and wash three times with ethanol to remove surfactants;

Step (d) then disperse the obtained product in 6 ml of DMF solvent and collect the hybrid metal nanomaterial of the ultrasensitive organometallic frame with a ratio of 1:2 stored at room temperature. The product yield obtained is over 85%.

### Example 3

Method for synthesizing hybrid metal nanomaterials with an organometallic framework using the metal-organic framework material MIL-100 (Fe) and nanometal gold with a volume ratio of 1:2

Step (a) create the reaction medium mixture by preparing the following precursor solutions:

Gold metal nano solution consisting of 100 ml of 1 mM gold (III) chloride trihydrate, 200 μl of 1 M sodium hydroxide (NaOH), 25 mg of sodium citrate tribasic dihydrate and 50 ml of distilled water stirred with a magnetic fish 15 minutes at 800 rpm at 100° C. and washed twice with distilled water.

MIL-100 (Fe) solution includes 8 ml of ferric trichloride hexahydrate concentration 15 mmol/l, 0.2 g of polyvinylpyrrolidone surfactant and 8 ml of N,N-dimethylformamide solution 15 mmol/l stirred for 20 minutes at a speed of 750 rpm at a temperature of 80° C. and washed twice with distilled water;

Step (b) dropwise add 4 ml of diluted gold nanometal solution to 2 ml of MIL-100 (Fe) solution prepared in step (a).

Step (c) keep the temperature stable at 25° C. and stir the mixture to perform the reaction for 8 hours;

Step (d) collect the product by centrifugation for 20 minutes at 4400 rpm and wash three times with ethanol to remove surfactants;

Step (d) then disperse the obtained product in 6 ml of DMF solvent and collect the hybrid metal nanomaterial of the ultrasensitive organometallic frame with a ratio of 1:2 stored at room temperature. The product yield obtained is over 82%.

### Example 4

Another exemplary method for synthesizing hybrid metal nanomaterials with organometallic frameworks using metal-organic framework materials MIL-100 (Fe) and gold nanomaterials with a volume ratio of 1:2

Step (a) create the reaction medium mixture by preparing the following precursor solutions:

Gold metal nano solution consisting of 100 ml of 1 mM gold (III) chloride trihydrate, 200 μl of 1 M sodium hydroxide (NaOH), 25 mg of sodium citrate tribasic dihydrate and 50 ml of distilled water stirred with a magnetic fish 15 minutes at 800 rpm at 100° C. and washed twice with distilled water.

MIL-100 (Fe) solution includes 8 ml of ferric trichloride hexahydrate concentration 15 mmol/l, 0.2 g of polyvinylpyrrolidone surfactant and 8 ml of N,N-dimethylformamide solution 15 mmol/l stirred for 20 minutes at a speed of 750 rpm at a temperature of 80° C. and washed twice with distilled water;

Step (b) dropwise add 4 ml of diluted gold nano solution to 2 ml of MIL-100 (Fe) solution prepared in step a).

Step (c) keep the temperature stable at 25° C. and stir the mixture to perform the reaction for 8 hours;

Step (d) collect the product by centrifugation for 20 minutes at 4400 rpm and wash three times with ethanol to remove surfactants;

Step (e) then disperse the obtained product in 6 ml of DMF solvent and collect the hybrid metal nanomaterial of the ultrasensitive organometallic frame with a ratio of 1:2 stored at room temperature. The product yield obtained is over 86%.

### Example 5

Yet another exemplary method for synthesizing hybrid metal nanomaterials with an organometallic framework using the metal-organic framework material MIL-100 (Fe) and nanometal iron oxide with a volume ratio of 1:2

Step (a) create the reaction medium mixture by preparing the following precursor solutions:

Iron oxide metal nano solution consisting of 0.9 g of ferric chloride, 1.2 g of unhydrous sodium acetate, 0.1 g of polyethylene glycol and 40 ml of ethylene glycol solution was stirred for 30 minutes at a speed of 800 rpm at a temperature of 190° C. and wash twice with ethanol.

MIL-100 (Fe) solution includes 8 ml of ferric trichloride hexahydrate concentration 15 mmol/l, 0.2 g of polyvinylpyrrolidone surfactant and 8 ml of N,N-dimethylformamide solution 15 mmol/l stirred for 20 minutes at a speed of 750 rpm at a temperature of 80° C. and washed twice with distilled water;

Step (b) dropwise add 4 ml of diluted gold nanometal solution to 2 ml of MIL-100 (Fe) solution prepared in step a).

Step (c) keep the temperature stable at 25° C. and stir the mixture to perform the reaction for 8 hours;

Step (d) collect the product by centrifugation for 20 minutes at 4400 rpm and wash three times with ethanol to remove surfactants;

Step (e) then disperse the obtained product in 6 ml of DMF solvent and collect the hybrid metal nanomaterial of the ultrasensitive organometallic frame with a ratio of 1:2 stored at room temperature. The product yield obtained is over 82%.

### Example 6

Another exemplary method for synthesizing hybrid metal nanomaterials with organometallic frameworks using metal-organic framework materials such as isoreticular metal organic framework-3 (IR MOF-3) and iron oxide nanometals with a volume ratio of 1:2.

Step (a) create the reaction medium mixture by preparing the following precursor solutions: Iron oxide metal nano solution consisting of 0.9 g of ferric chloride, 1.2 g of unhydrous sodium acetate, 0.1 g of polyethylene glycol and 40 ml of ethylene glycol solution was stirred for 30 minutes at a speed of 800 rpm at a temperature of 190° C. and Wash twice with ethanol.

IR MOF-3 solution includes 35.12 mg of zinc acetate salt, 10.86 mg of 2-aminoterephthalic acid, 10 mg of cetyl trimethyl ammonium bromide (CTAB) and 7.5 mg of polyvinylpyrrolidone (PVP) surfactant and 5 ml of N,N-solution dimethylformamide was stirred with a magnet for 30 minutes at a speed of 950 rpm at room temperature. 170° C. and washed twice with ethanol;

Step (b) dropwise add 4 ml of diluted gold nanometal solution to 2 ml of IR MOF-3 solution prepared in step (a).

Step (c) keep the temperature stable at 25° C. and stir the mixture to perform the reaction for 8 hours;

Step (d) Collect the product by centrifugation for 20 minutes at 4500 rpm and wash three times with ethanol to remove surfactants;

Step (e) then disperse the obtained product in 6 ml of DMF solvent and collect the hybrid metal nanomaterial of the ultrasensitive organometallic frame with a ratio of 1:2 stored at room temperature. The product yield obtained is over 85%.

### Example 7

Method for synthesizing hybrid metal nanomaterials with organometallic frameworks (SiO₂/OH/AuZIF8) using metal-organic framework materials (ZIF8) and iron oxide nanometals with a volume ratio of 1:2

Step (a) create the reaction medium mixture by preparing the following precursor solutions:

Iron oxide metal nano solution consisting of 0.9 g of ferric chloride, 1.2 g of unhydrous sodium acetate, 0.1 g of polyethylene glycol and 40 ml of ethylene glycol solution was stirred for 30 minutes at a speed of 800 rpm at a temperature of 190° C. and wash twice with ethanol.

The ZIF 8 solution includes 1 ml of zinc acetate salt concentration 20 nM, 1 ml of 2-methylimidazole concentration 1.3 M and 100 ml of methanol solution stirred with a magnet for 24 hours at a speed of 750 rpm at temperature 25° C. and wash three times with methanol;

Step (b) dropwise add 4 ml of diluted gold nanometal solution to 2 ml of ZIF 8 solution prepared in step (a).

Step (c) keep the temperature stable at 25° C. and stir the mixture to perform the reaction for 8 hours;

Step (d) collect the product by centrifugation for 20 minutes at 4500 rpm and wash three times with ethanol to remove surfactants;

Step (e) then disperse the obtained product in 6 ml of DMF solvent and collect the hybrid metal nanomaterial of the ultrasensitive organometallic frame with a ratio of 1:2 stored at room temperature. The product yield obtained is over 85%

### Efficiency Achieved by the Invention

The invention refers to an ultrasensitive sensor organometallic hybrid metal nanomaterial that is capable of ultrasensitive sensing of target molecules with a limit of 81.9 nM, making it easy to absorb and detect the existence of toxic substances in food and the environment. The organometallic framework hybrid metal nanomaterial reaches the limit of detecting the existence of NFT molecules, and also shows the ability to enhance the optical fiber sensor signal with NFT molecules reaching 35.8 μM. This method of synthesizing materials is low cost, uses less toxic chemicals, has a short reaction time, and can be synthesized in large quantities on an industrial scale.

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

The foregoing description details certain embodiments of the invention. It will be appreciated, however, that no matter how detailed the foregoing appears in text, the invention can be practiced in many ways. As is also stated above, it should be noted that the use of particular terminology when describing certain features or aspects of the invention should not be taken to imply that the terminology is being re-defined herein to be restricted to including any specific characteristics of the features or aspects of the invention with which that terminology is associated. The scope of the invention should, therefore, be construed in accordance with the appended claims and any equivalents thereof.

### EXPLANATION OF REFERENCE NUMERALS

301 silicate (SiO₂) substrate
311 oxygen species
312 hydroxyl (OH) functional group
321 AuZIF 8 crystals
331 SiO₂ modified by OH substrate
332 AuZIF 8 crystals bound to SiO₂ substrate by OH group
400 SERS sensor
401 He/Ne laser source
402 fiber optics cables
403 optical coupler
404 photodetector
405 electrical cable
406 computer
411 inlet channel
412 Si/OH/Au-ZIF 8 platform
413 outlet channel
430 Si/OH/Au-ZIF 8 platform

What is claimed is:

1. A surface enhanced Raman spectroscopy sensor (SERS sensor), comprising:
a laser source;
an input fiber optic cable;
a microfluidic chip coupled to said input fiber optic cable, said microfluidic chip further comprising an inlet channel, a Si/OH/Au-ZIF8 platform, and an inlet channel;
a micro-pump device, coupled to said inlet channel, operable to pump a sample from said inlet channel to said outlet channel via said Si/OH/Au-ZIF8 platform;
an output fiber optic cable couple to said outlet channel; and
a computer, electrically coupled to said output fiber optic cable.

2. The SERS sensor of claim 1 wherein said laser source is a 5 mW He/Ne laser with an absorption wavelength of 632.8 nm.

3. The SERS sensor of claim 1 wherein said Si/OH/Au-ZIF8 platform further comprises a silica (SiO₂) substrate bonded with hydroxyl functional group (—OH) which is bonded with Au-ZIF8 hexagon whose gold (Au) nanomaterials have a dimension from 15 nm to 25 nm.

4. The SERS sensor of claim 3 wherein a ZIF8 moiety of said Si/OH/Au-ZIF8 platform is synthesized from isoreticular metal organic framework-3 (IMROF-3) and said gold nanomaterials whose volume ratio is 1:2.

5. The SERS sensor of claim 3 wherein an Au-ZIF8 moiety of said Si/OH/Au-ZIF8 platform is synthesized from MIL-100 (Fe) and said gold (Au) nanomaterials whose volume ratio is 1:2.

6. The SERS sensor of claim 3 wherein a Au-ZIF8 moiety of said Si/OH/Au-ZIF8 platform is synthesized from MIL-100 (Fe) and a nanometal iron oxide with a volume ratio of 1:2.

7. The SERS sensor of claim 3 wherein a Au-ZIF8 moiety of said Si/OH/Au-ZIF8 platform is synthesized from an organometallic framework AuZIF8 and a nanometal iron oxide with a volume ratio of 1:2.

8. The SERS sensor of claim 7 wherein surfaces of said Si/OH/Au-ZIF8 platform are prepared by a plasma oxidation process.

9. The SERS sensor of claim 1 further comprising an optical coupler, coupled to said laser source and said input fiber optic cable.

10. The SERS sensor of claim 1 further comprising a photodetector coupled to said computer and said outlet channel of said microfluidic chip for measuring Raman scattering frequencies of said liquid.

11. A method for detecting foreign traces in a test liquid, comprising:
(a) flowing said test liquid through an inlet channel, a Si/OH/Au-ZIF8 platform, and an outlet channel of a microfluidic chip of a SERS sensor;
(b) turning on a He/Ne laser source of said SERS sensor;
(c) receiving scattering frequencies from said test liquid through said Si/OH/Au-ZIF8 platform using a photodetector of said SERS sensor; and
(d) measuring intensities of said scattering frequencies using a computer of said SERS sensor.

12. The method of claim 11 wherein said He/Ne laser source has a power of 5 mW an absorption wavelength of 632.8 nm.

13. The method of claim 12 wherein said Si/OH/Au-ZIF8 platform further comprises a silica (SiO₂) substrate bonded with hydroxyl functional group (—OH) which is bonded with Au-ZIF8 hexagon whose gold (Au) nanomaterials have a dimension from 15 nm to 25 nm.

14. The method of claim 13 wherein a ZIF8 moiety of said Si/OH/Au-ZIF8 platform is synthesized from IMROF-3 and said gold nanomaterials whose volume ratio is 1:2.

15. The method of claim 13 wherein a AuZIF8 moiety of said Si/OH/Au-ZIF8 platform is synthesized from MIL-100 (Fe) and said gold (Au) nanomaterials whose volume ratio is 1:2.

16. The method of claim 13 wherein said AuZIF8 moiety of said Si/OH/Au-ZIF8 platform is synthesized from MIL-100 (Fe) and a nanometal iron oxide with a volume ratio of 1:2.

17. The method of claim 13 wherein said AuZIF8 moiety of said Si/OH/Au-ZIF8 platform is synthesized from an organometallic framework AuZIF8 and a nanometal iron oxide with a volume ratio of 1:2.

18. A method of fabricating an surface enhanced Raman spectroscopy (SERS) sensor, comprising:
connecting a laser source to an input fiber optics cable;
connecting a microfluidic chip to said input fiber optic cable, said microfluidic chip further comprising an inlet channel, a Si/OH/Au-ZIF8 platform, and an inlet channel;
connecting a micro-pump device to said inlet channel;
connecting an output fiber optic cable couple to said outlet channel; and
connecting a computer to said output fiber optic cable using a photodetector.

19. The method of claim 18 wherein preparing said Si/OH/Au-ZIF8 platform by bonding a silica (SiO₂) substrate with hydroxyl functional group (OH) and Au-ZIF8 hexagon whose gold (Au) nanomaterials have a dimension from 15 nm to 25 nm.

20. The SERS sensor of claim 19 wherein said ZIF8 moiety of said Si/OH/Au-ZIF8 platform is synthesized from isoreticular metal organic framework-3 (IMROF-3) and said gold nanomaterials whose volume ratio is 1:2.
